(19) United States
(12) Patent Application Publication
(10) Pub. No.: US 2013/0322829 A1
(43) Pub. Date: Dec. 5, 2013

(54) OPTICAL-ELECTRICAL TRANSMISSION ASSEMBLY AND OPTICAL TRANSMISSION MODULE USING THE SAME

(71) Applicant: HON HAI PRECISION INDUSTRY CO., LTD., New Taipei (TW)

(72) Inventor: KUO-FONG TSENG, New Taipei (TW)

(73) Assignee: HON HAI PRECISION INDUSTRY CO., LTD., New Taipei (TW)

(21) Appl. No.: 13/847,035

(22) Filed: Mar. 19, 2013

(30) Foreign Application Priority Data
May 31, 2012 (TW) 101119524

(51) Int. Cl. G02B 6/43

(52) U.S. Cl. CPC G02B 6/43
USPC 385/89

(57) ABSTRACT

An optical transmission module includes two optical-electrical transmission assemblies and at least two optical waveguides including two fixing ends. Each optical-electrical transmission assembly includes a CMOS board, an integrated IC driver chip mounted on the CMOS board, an light emitting element array, and at least one photodetector element. The integrated IC driver chip includes an output end and an input end. The light emitting element array is positioned on the CMOS board, and is electrically connected with the output end. The at least one photodetector element is positioned on the CMOS board, and is electrically connected with the input end. One fixing end of each optical waveguide is positioned on one CMOS board and is optically coupled with the light emitting element array. The other fixing end of each optical waveguide is positioned on another CMOS board and is optically coupled with the photodetector element.

### PRIORITY

This application claims all benefits and priority accruing under 35 U.S.C. §119 from Taiwan Patent Application No. 101119524, filed on May 31, 2012, in the Taiwan Intellectual Property Office, the disclosure of which is incorporated herein by reference.

### BACKGROUND

1. Technical Field

The present disclosure relates to transmission assemblies, particularly to an optical-electrical transmission assembly and an optical transmission module using the optical-electrical transmission assembly.

2. Description of Related Art

Optical communication is popular. During chip packaging of an optical transmission module, optical members are packaged on a circuit board, and a plastic cover is fixed on the circuit board and is positioned above the optical members. Optical fibers are fixed on the plastic cover via an UV-cured glue, and are optically coupled with the optical members via lenses. Photoelectric characteristics testing will be performed after the completion of the assembly of the optical transmission module with such aforementioned structure. Because different members are assembled in different processes according to their materials, all the members of the optical transmission module would be rejected and abandoned together if the optical transmission module is not qualified as passing quality inspection. Thus, it may lower the yield and increase the cost of the optical transmission module.

Therefore, there is room for improvement in the art.

### BRIEF DESCRIPTION OF THE DRAWINGS

The components in the drawing are not necessarily drawn to scale, the emphasis instead being placed upon clearly illustrating the principles of the present disclosure.

FIG. 1 is a diagram of an embodiment of an optical transmission module.

### DETAILED DESCRIPTION

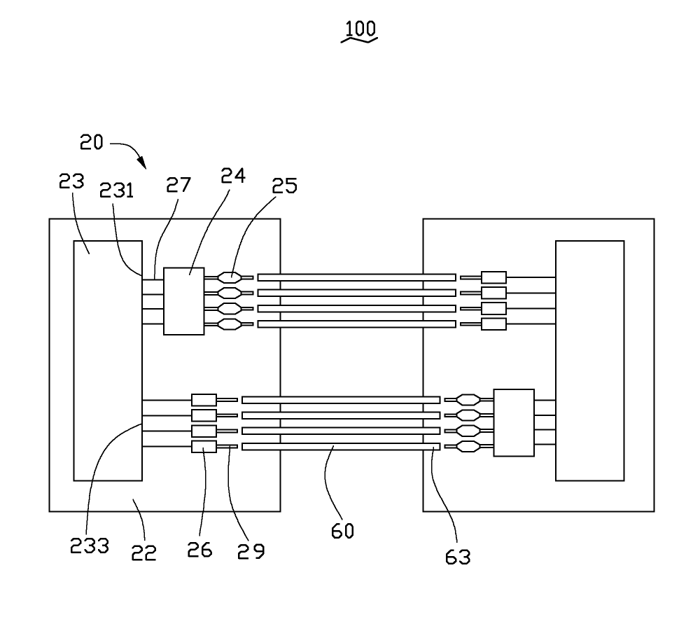

FIG. 1 shows an optical transmission module 100 which includes two optical-electrical transmission assemblies 20 and eight optical waveguides 60. The eight optical waveguides 60 are connected between the two optical-electrical transmission assemblies 20, respectively.

The optical-electrical transmission assembly 20 includes a complementary metal oxide semiconductor (CMOS) board 22, an integrated IC driver chip 23, a light emitting element array 24, four optical modulators 25, four photodetector elements 26, eight electrical conductive wires 27, and eight optical fibers 29. The integrated IC driver chip 23 is mounted on a side of the CMOS board 22. The integrated IC driver chip 23 includes an output end 231 and an input end 233 opposite to the output end 231. The light emitting element array 24 is positioned on the CMOS board 22 adjacent to the output end 231. The light emitting element array 24 is electrically connected with the output end 231 via four electrical conductive wires 27, for converting electrical signals from the output end 231 to optical signals. Four optical modulators 25 are positioned on each of the CMOS board 22, and are substantially parallel to each other. Each optical modulator 25 is optically coupled with the light emitting element array 24 via one optical fiber 29 to modulate optical signals exiting from the light emitting element array 24 to be high speed optical signals for transmitting. The light emitting element array 24 is positioned between the integrated IC driver chip 23 and the optical modulators 25. The four photodetector elements 26 are positioned on the CMOS board 22, and are substantially parallel to each other. Each photodetector element 26 is electrically coupled with the input end 233 via one electrical conductive wire 27. In the illustrated embodiment, the light emitting element array 24 is a laser diode array. The photodetector elements 26 are photodiodes.

The eight optical waveguides 60 are connected between the two transmission assemblies 20, respectively. Each optical waveguide 60 includes opposite fixing ends 63. One fixing end 63 of each optical waveguide 60 is fixed on the CMOS board 22 of one of the two optical-electrical transmission assemblies 20 and is optically-coupled with a corresponding photodetector element 26 via one optical fiber 29, the other one fixing end 63 is fixed on the CMOS board 22 of the other one optical-electrical transmission assembly 20, and is optically-coupled with a corresponding optical modulator 25 via one optical fiber 29. In the illustrated embodiment, the optical waveguide 60 is made of semi-conductive material.

In assembly, the integrated IC driver chip 23 is mounted on the CMOS board 22. The light emitting element array 24 is positioned adjacent to the output end 231 on the CMOS board 22. The light emitting element array 24 is electrically connected with the output end 231 via the electrical conductive wires 27. The four optical modulators 25 are positioned on the CMOS board 22, and are optically coupled with the light emitting element array 24 via the optical fibers 29. The four photodetector elements 26 are positioned adjacent to the input end 233 on the CMOS board 22, and are electrically-connected with the input end 233. Thus, one optical-electrical transmission assembly 20 is completely assembled. Then the other one optical-electrical transmission assembly 20 is also assembled in the same manner. Later, the eight optical waveguides 60 are connected between the two optical transmission assemblies 20, respectively.

In use, the two optical transmission assembles 20 are positioned on two different electronic devices. The light emitting element array 24 receives the electrical signals from the integrated IC driver chip 23 and converts the electrical signals to optical signals. The optical signals are transmitted to the optical modulator 25. The optical modulator 25 modulates the optical signals to become the high speed optical signals. The high speed optical signals are transmitted to the photodetector elements 26 of the other one optical-electrical transmission assembly 20 via the optical waveguides 60, and are converted to electrical signals by the photodetector elements 26. Then, data are transmitted from one optical-electrical transmission assembly 20 to the other optical-electrical transmission assembly 20. Data also can be bi-directionally transmitted between the two optical transmission assemblies 20 when both of the two light emitting element array 24 are sending optical signals.

Because the CMOS board 22 is being used as a base board, all of the members and components for each optical-electrical transmission assembly 20 can be assembled and tested in a semiconductor process. Any member or component can be changed or switched with a new one if the corresponding member is found to be of not qualified as passing quality inspection. The optical transmission assembly 20 has a simpler structure, and a lower cost.

In other embodiments, the number of the photodetector elements 26 can be changed according to real-application needs, and the number of the optical modulators 25 and the number of the optical waveguides 60 can be changed correspond to the number of the photodetector elements 26.

In other embodiments, the optical modulators 25 can be omitted.

It is believed that the present embodiments and their advantages will be understood from the foregoing description, and it will be apparent that various changes may be made thereto without departing from the spirit and scope of the embodiments or sacrificing all of its material advantages.

What is claimed is:

1. An optical transmission module, comprising:
two optical-electrical transmission assemblies, each of the two optical-electrical transmission assemblies comprising:
a CMOS board;
an integrated IC driver chip mounted on the CMOS board, the integrated IC driver chip comprising an output end and an input end opposite to the output end;
a light emitting element array positioned on the CMOS board and electrically connected with the output end; and
at least one photodetector element positioned on the CMOS board, and electrically connected with the input end; and
at least two optical waveguides, each of the at least two optical waveguides comprising two fixing ends,
wherein one of the two fixing ends of each of the at least two optical waveguides is positioned on the CMOS board of one of the two optical-electrical transmission assembles, and is optically-coupled with the light emitting element array, the other one of the two fixing ends of each of the at least two optical waveguides is positioned on the CMOS board of the other one of the two optical-electrical transmission assemblies, and is optically-coupled with the at least one photodetector element.

2. The optical transmission module of claim 1, wherein each optical-electrical transmission assembly further comprises at least one optical modulator, the at least one optical modulator is optically-coupled with the light emitting element array and one of the two fixing ends of each of the at least two optical waveguides.

3. The optical transmission module of claim 1, wherein the light emitting element array comprises a laser diode array.

4. The optical transmission module of claim 1, wherein the at least one photodetector element comprises a photodiode.

5. The optical transmission module of claim 1, wherein each optical-electrical transmission assembly further comprises a plurality of electrically conductive wires, the light emitting element array is electrically connected with the output end via the plurality of electrically conductive wires, and the at least one photodetector element is electrically connected with the input end via one of the plurality of electrical conductive wires.

6. An optical-electrical transmission assembly comprising:
a CMOS board;
an integrated IC driver chip mounted on the CMOS board, the integrated IC driver chip comprising an output end and an input end opposite to the output end;
a light emitting element array positioned on the CMOS board and electrically connected with the output end; and
at least one photodetector element positioned on the CMOS board and electrically connected with the input end; and
at least two optical waveguides, each of the at least two optical waveguides comprising opposite fixing ends.

7. The optical-electrical transmission assembly of claim 6, wherein each optical-electrical transmission assembly further comprises at least one optical modulator, the at least one optical modulator is optically coupled with the light emitting element array.

8. The optical-electrical transmission assembly of claim 6, wherein the light emitting element array comprises a laser diode array.

9. The optical-electrical transmission assembly of claim 6, wherein the at least one photodetector element comprises a photodiode.

10. The optical transmission module of claim 1, wherein each optical-electrical transmission assembly further comprises a plurality of electrically conductive wires, the light emitting element array is electrically connected with the output end via the plurality of electrically conductive wires, and the at least one photodetector element is electrically connected with the input end via one of the plurality of electrical conductive wires.
